(19) United States
(12) Patent Application Publication
(10) Pub. No.: US 2012/0024113 A1
(43) Pub. Date: Feb. 2, 2012

(54) BOTTLE OPENING METHOD AND APPARATUS

(76) Inventor: BEN FOCHT, DENVER, CO (US)

(21) Appl. No.: 12/847,155

(22) Filed: Jul. 30, 2010

(51) Int. Cl. B67B 7/16

(52) U.S. Cl. 81/3.55

(57) ABSTRACT

A bottle opening device for opening a bottle having a bottle cap and methods for achieving the same are herein disclosed. The bottle opening device includes an elongated handle with an embedded tooth. The tooth and a surface of the elongated handle where the tooth is embedded are engaged with the bottle cap. The elongated handle is pivoted around the edge of the bottle cap where the elongated handle contacts the bottle cap. This pivoting motion causes the tooth to pull against the bottle cap and disengage it from the bottle. The elongated handle can be made of wood and can have a flat side surface that facilitates display of logos, messages, and/or images.

### FIELD OF INVENTION

This disclosure describes systems and methods for disengaging a bottle cap from a bottle.

### BACKGROUND OF THE INVENTION

A bottle cap can be affixed to the rim of the neck of a bottle. A bottle opener is a lever that grabs the bottle cap and uses a point on the bottle cap as a fulcrum on which to pivot. Bottle openers are typically pull-type, meaning that an upward motion on the lever is used along with a fulcrum that is often near the center of the bottle cap such that the cap is creased as the bottle opener pivots on the fulcrum.

Bottle openers are commonly used devices that have great potential for use in advertising and marketing. However, many bottle openers do not have large surfaces upon which logos, messages, and images can be printed, affixed, or embossed.

### SUMMARY OF THE INVENTION

This disclosure describes systems and methods for disengaging a bottle cap from a bottle. One aspect discloses a device for disengaging a bottle cap from a bottle. The device includes an elongated handle and a tooth embedded in the elongated handle. The elongated handle has a first half and a second half and a long axis. A pivot surface of the elongated handle contacts a first edge on a bottle cap at a pivot axis. The elongated handle pivots around the pivot axis. The pivot axis is preferably perpendicular to the long axis. The tooth has a first portion extending from, e.g., substantially perpendicular to, the pivot surface of the elongated handle. The tooth has a second portion angled in relation to the first portion. The second portion preferably has an arcuate end shaped to engage a neck of the bottle. The arcuate end engages the neck of the bottle and a bottom of the bottle cap. The elongated handle pivots around the pivot axis causing the tooth to force at least a portion of the bottle cap off of the bottle.

Another aspect discloses a method of disengaging a bottle cap from a bottle. The method includes a first engaging step, a second engaging step, and a pivoting step. The first engaging step involves engaging a neck of the bottle and a bottom of the bottle cap with a tooth of a bottle opening device. The second engaging step involves engaging a first edge of the bottle cap with a pivot surface of the bottle opening device. The pivoting step involves pivoting the bottle opening device about the first edge of the bottle until the tooth forces at least a portion of the bottle cap to disengage from the bottle. In one implementation, the first edge of the bottle, about which the opening device pivots, is substantially diametrically opposite the point where the tooth engages the bottle opening device. The step of pivoting preferably involves gripping a handle and moving the handle downwardly. Generally, the user may grip the bottle with one hand and the handle of the bottle opening device with the other hand, and then move the hands toward one another to open the bottle. It is believed that this may be an easier operation for certain people with limited mobility or strength. The order of the first and second engaging steps is reversible.

In a third aspect a tooth of a bottle opening device is disclosed. The tooth includes an attachment portion, a first portion, and a second portion. The attachment portion secures the tooth to the bottle opening device. The first portion is aligned with the attachment portion and protrudes from a pivot surface of the bottle opening device. The second portion is substantially perpendicular to the first portion and includes an arcuate end shaped to engage the neck of a bottle and a bottom surface of a bottle cap attached to the bottle.

### BRIEF DESCRIPTION OF THE DRAWINGS

For a more complete understanding of the present invention and further advantages thereof, reference is now made to the following detailed description taken in conjunction with the drawings in which:

FIGS. 1a, 1b, and 1c illustrate an embodiment of a bottle opening device in three stages of a process of disengaging a bottle cap from a bottle.

FIGS. 2a, 2b, and 2c illustrate the device from a side view, overhead view, and head-on view, respectively.

FIGS. 3a, 3b, and 3c illustrate the tooth comprising an attachment portion, a first portion, and a second portion.

FIG. 4 illustrates a method of disengaging a bottle cap from a bottle using the above-described device.

### DETAILED DESCRIPTION

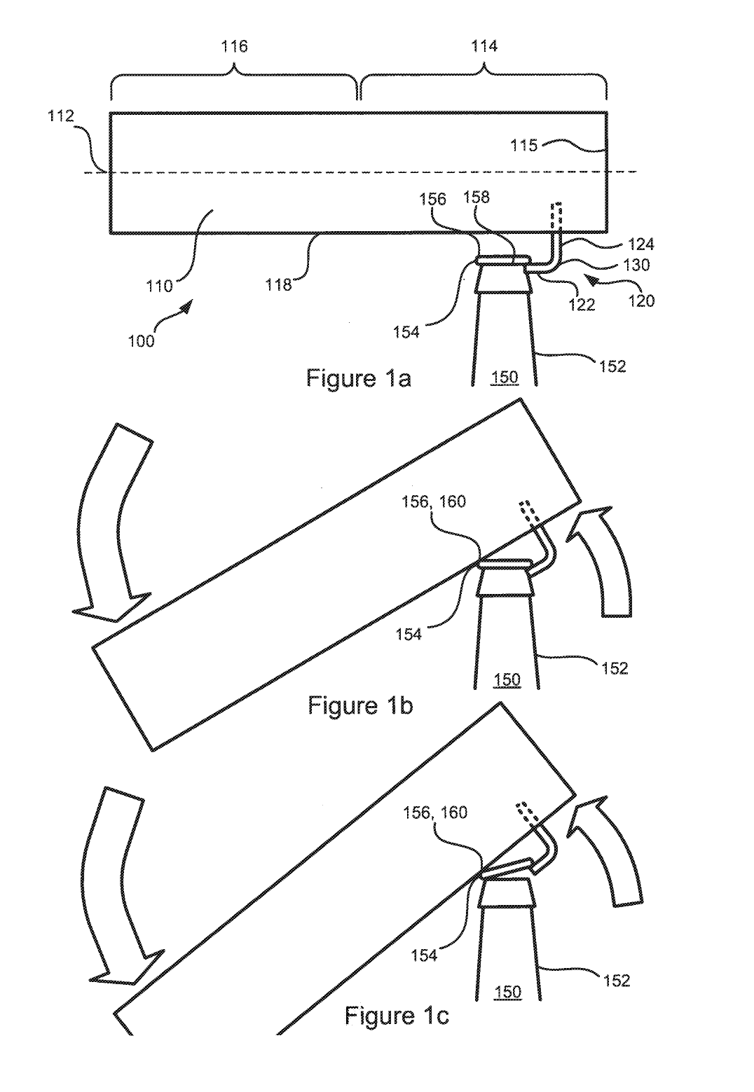

The present disclosure describes a device for disengaging a bottle cap from a bottle. FIGS. 1a, 1b, and 1c illustrate an embodiment of a bottle opening device in three stages of a process of disengaging a bottle cap from a bottle. The bottle 150 includes a neck 152 and a bottle cap 154. The device 100 includes an elongated handle 110 and a tooth 120 attached to the elongated handle 110. The tooth 120 can be embedded in the elongated handle 110 and secured there either via friction, a securing chemical composition, or a combination of the two. With the tooth 120 engaged with the bottle cap 156, the elongated handle 110 can be pivoted (see FIGS. 1b and 1c) about a pivot axis 160 to at least partially disengaged the bottle cap 154 from the bottle 150. While many bottle openers use an upward or pulling force to remove bottle caps, the device 100 uses a downward or pushing motion. Furthermore, while conventional pulling bottle openers have a pivot point that is often near a center of the bottle cap, the device 100 has a pivot axis 160 that is at an edge of the bottle/bottle cap, specifically on the same side of the bottle as the elongated handle 110.

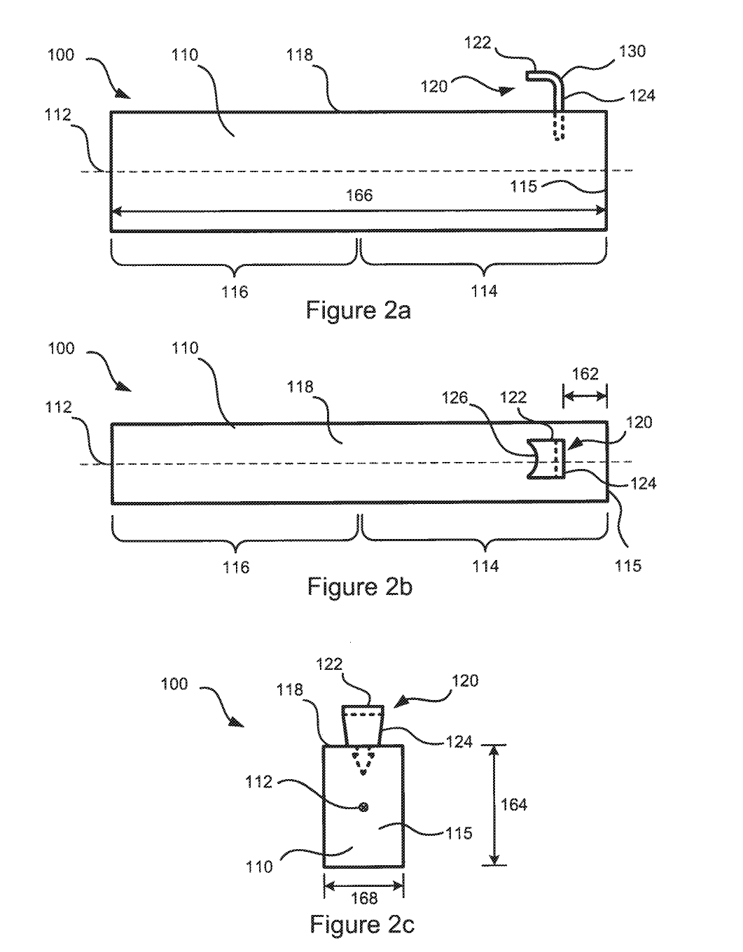

FIGS. 2a, 2b, and 2c illustrate the device 100 from a side view, overhead view, and head-on view, respectively. The elongated handle 110 has a first half 114 and a second half 116. The elongated handle 110 has a long axis 112, which is parallel with a length 166 of the elongated handle 110. The long axis 112 passes through a center of the handle as illustrated in FIG. 2c. The elongated handle 110 includes a pivot surface 118. The pivot surface 118 receives the tooth 120 and is configured to contact a first edge 156 of the bottle cap 154. The elongated handle 110 is configured to pivot about the pivot axis 160, which passes either through or adjacent to a point on the pivot surface 118 configured to contact the first edge 156 of the bottle cap 154. As the exact location of the pivot axis 160 may vary from that illustrated in FIG. 1b, or even move during the pivoting of the elongated handle 110, the pivot axis 160 may be said to be located adjacent to the first edge 156. In the illustrated embodiment, the pivot axis 160 is perpendicular to the long axis 112. The device 100 can be used to disengage a bottle cap 154 from any type of bottle 150 having a bottle cap 154 (e.g., soda bottles and beer bottles, to name two).

The elongated handle 110 can take a variety of shapes. For instance, as illustrated, the elongated handle 110 can be rectangular. In other words, neither the length 166, width 168, nor height 164 are equal. In other embodiments, two or more of the length 166, width 168, and height 164 can be equal. In another embodiment, the elongated handle 110 can be cylindrical. Thus, when viewed head-on the elongated handle 110 would have a circular profile rather than the rectangular one illustrated in FIG. 2c. In another embodiment, the elongated handle 110 can have an elliptical profile when viewed head-on. Other profiles such as triangles, pentagons, hexagons, trapezoids, parallelograms, and many others can also be implemented without going beyond the intent of this disclosure.

The illustrated handle 110 has a length shown by arrows 166. The length 166 is preferably between five and ten inches. In one embodiment, the elongated handle 110 has a length 166 of about eight inches. The illustrated handle 110 further has a width indicated by arrows 168; the width 168 is preferably between one half-inch and three inches. The elongated handle 110 also has a height indicated by arrows 164. In one embodiment, the height 164 is between three fourths of an inch and three inches.

The device 100 can be made from a variety of materials. For instance, in one embodiment, the elongated handle 110 can be wood. In an embodiment, the tooth 120 can be metal. In another embodiment, either or both of the elongated handle 110 and the tooth 120 can be a polymer. The polymer may be a rigid polymer. Either or both of the elongated handle 110 and the tooth 120 can be a glass or ceramic although such materials, if prone to cracking may not be preferable. In an embodiment, the elongated handle 110 can be made from two or more materials. For instance, a bulk of the elongated handle 110 including the pivot surface 118 can be made of wood, while a small portion of the elongated handle 110 near where a user would grasp the elongated handle 110 might have a polymer coating. As another example, the elongated handle 110 could be primarily wood, but may be partially or wholly painted or covered with some other material used to display a logo or message. The elongated handle 110 and the tooth 120 can be made from a variety of other rigid materials without going beyond the intent of this disclosure.

In one embodiment, the elongated handle 110 can be used to display one or more logos, messages, or images. For instance, a company logo could be painted or engraved onto a side of the elongated handle 110. In an embodiment, a metal plaque can be attached to a side of the elongated handle 110 where the plaque has a message, logo, or image embossed in the metal. Various other means of displaying a logo, message, or image on the side of the elongated handle 110 can also be implemented without going beyond the intent of this disclosure.

The illustrated tooth 120 includes a first portion 124 and a second portion 122. The first portion 124 can be substantially perpendicular to the pivot surface 118 and is attached to the elongated handle 110. The second portion 122 is preferably angled substantially perpendicular to the first portion 124. Substantially perpendicular includes the angles 80° to 95°. In a particular embodiment, the angle between the first portion 124 and the second portion 122 is 90°. While the first portion 124 is preferably perpendicular to the pivot surface 118, the first portion 124 can also be angled relative to the pivot surface 118. The second portion 122 is preferably substantially parallel to the axis 112.

The first and second portions 124, 122 are joined by an angled portion 130. The angled portion 130 can be angled (i.e., comprising a sharp angle) or curved or beveled. While the illustrations show the angled portion 130 as being curved and as having a particular curvature, one skilled in the art will recognize that various angles and various curvatures can be implemented without deviating from the intent of this disclosure.

The second portion 122 includes an arcuate end 126 shaped to engage the bottle neck 152. The arcuate end 126 engages the bottle neck 152 and a bottom 158 of the bottle cap 154. Once the pivot surface 118 is in contact with the first edge 156 of the bottle cap 154 and the tooth 120 is engaged with the bottle neck 152 and the bottom 158 of the bottle cap 154, the elongated handle 110 can pivot about the pivot axis 160 causing the tooth 120 to force at least a portion of the bottle cap 154 off of the bottle 150.

The tooth 120 is attached to the first half 114 of the elongated handle 110. In particular, the tooth 120 can be positioned closer to an end 115 of the first half 114 than to a middle point on the pivot surface 118. The tooth 120 can be a distance 162 from the end 115 of the first half 114. In an embodiment, the distance 162 is one to two inches.

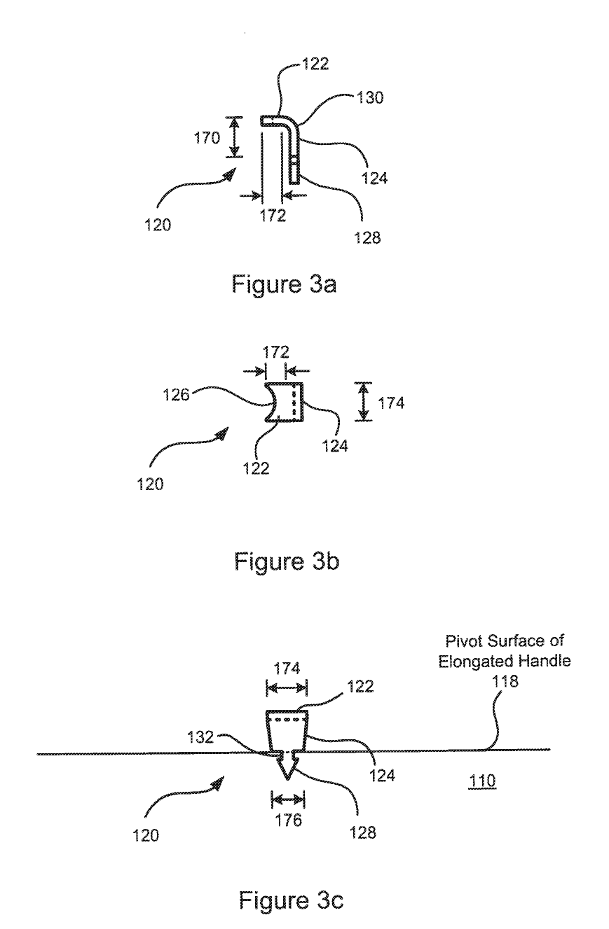

FIGS. 3a, 3b, and 3c illustrate the tooth 120 comprising an attachment portion 128, a first portion 124, and a second portion 122. In FIG. 3b the arcuate end 126 is convex. In an embodiment, the arcuate end 126 has an elliptical shape. In the illustrated embodiment, the arcuate end 126 has a circular shape. In an embodiment where the arcuate end 126 has a circular shape, the arcuate end can have about a one-half inch radius to substantially match the curvature of a typical bottle neck. Other curvatures may be used for other bottles. In embodiments where the arcuate end 126 has an elliptical shape, the minor axis of the elliptical shape can have a radius of one-half inch. It should be understood that many other radii can also be implemented with either the circular or elliptical embodiments of the arcuate end 126.

The second portion 122 is illustrated as having a square shape with an arcuate end 126. However, in other embodiments, the second portion 122 can have other shapes. For instance, the second portion 122 could be tapered from the arcuate end 126 towards the first portion 124 (i.e., wider near the arcuate end 126).

The tooth 120 can be embedded in the elongated handle 110 as illustrated in FIG. 3c. As illustrated, the first portion 124 is tapered from the second portion 122 towards the elongated handle 110 (i.e., widest near the second portion 122). However, this tapering is not required, and the first portion 124 can also be rectangular or square-shaped rather than tapered. The attachment portion 128 is configured to secure the tooth 120 to the elongated handle 110. As illustrated, the attachment portion 128 is completely embedded within the elongated handle 110. However, no portion of the first portion 124 is embedded within the elongated handle 110. In practice however, there may be some leniency such that the attachment portion 128 is not completely embedded within the elongated handle 110 or the first portion 124 may be partially embedded in the elongated handle 110.

In an embodiment, the attachment portion 128 can be shaped like an arrow or a triangle, in other words, it can be arrow-shaped. Such a shape facilitates embedding of the tooth 120 into the elongated handle 110. The arrow shape along with a causeway 132 connecting the arrow-shaped portion to the first portion 124, also has the same effect as a real life arrow or barb in that the arrow or barb or, in this case, the attachment portion 128, easily moves into the elongated handle 110, but is difficult to remove.

As illustrated, the bottom of the first portion 124 is wider than the attachment portion 128. This may ease manufacturing by making it easy to embed the attachment portion 128 in the elongated handle 110, but difficult to embed the first portion 124. As such, if the amount of force used to embed the tooth 120 is kept constant for all teeth, then each tooth can be embedded into an elongated handle 110 such that only the attachment portion 128 is inside the elongated handle 110. In other words, since the attachment portion 128 can be embedded using less force than embedding the first portion 124, using a force that is greater than that required to embed the attachment portion 128, but less than that required to embed the first portion 124 will make it highly likely that only the attachment portion 128 will be embedded. Put another way, while the attachment portion 128 may with ease be embedded within the elongated handle 110, the hole or slot in the elongated handle 110 formed by the attachment portion 128 being driven into the elongated handle 110 will not be wide enough to accept the first portion 124. As such, the first portion 124 will not be driven into or embedded in the elongated handle 110 unless additional force is applied. As such, embedding the tooth 120 into the elongated handle 110 to a specified depth can be performed repeatedly with minimal effort, skill, or accuracy on the part of a human or automated fabricator. The shape of the attachment portion 128 can facilitate manufacturing where the elongated handle 110 is made from wood, by avoiding splitting the wood. For instance, shapes of the attachment portion 128 other than the one illustrated in FIGS. 3a, 3b, and 3c can cause a wooden elongated handle 110 to split or fracture. The arrow or triangular shape as illustrated avoids this problem.

The tooth 120 can have width 176 where the first portion 124 meets the elongated handle 110. In an embodiment, the width 176 is one eighth of an inch. The tooth 120 can have a width 174 of the second portion 122. In an embodiment, the width 174 is seven sixteenths of an inch. The tooth 120 can have a distance 172 defined as the distance between an end of the second portion 122 and the start of the angled portion 130. In an embodiment, this distance 172 is three eighths of an inch. The tooth 120 can have a height 170 spanning from the second portion 122 to the attachment portion 128. In an embodiment, the height 170 is three eighths of an inch. In an embodiment, the tooth 120 can be made from a single material that is bent such that the first and second portions 124, 122 are substantially perpendicular to each other. In an embodiment, this length of material is between one inch and one and a quarter inches in length.

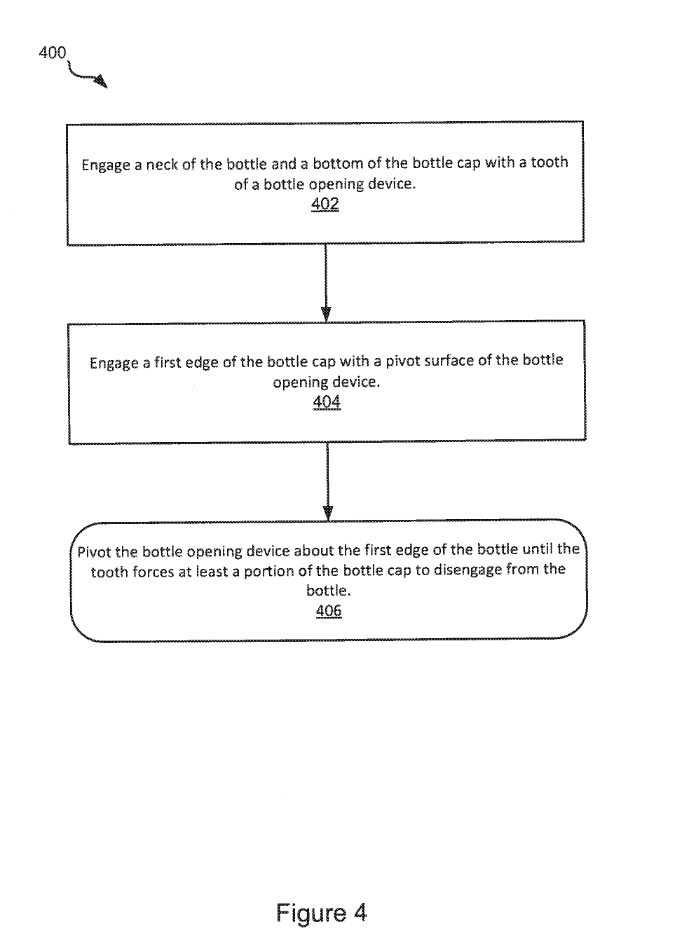

FIG. 4 illustrates a method of disengaging a bottle cap from a bottle using the above-described device 100. The method 400 can be carried out in at least three operations 402, 404, 406. The tooth of a bottle opening device can be engaged with a bottle neck and a bottom of the bottle cap in an engage operation 402. A pivot surface of the bottle opening device can be caused to come into contact with an edge of the bottle cap opposite from where the tooth engages the bottle in a cause operation 404. The order of these two operations is interchangeable. Once both the engaging and the causing operations have been carried out, the bottle opening device is pivoted about the edge of the bottle cap in contact with the pivot surface of the bottle opening device until the tooth forces at least a portion of the bottle cap to disengage from the bottle in a pivot operation 406.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such or other embodiments and with various modifications required by the particular application(s) or use(s) of the present invention. It is intended that the appended claims be construed to include alternative embodiments to the extent permitted by the prior art.

What is claimed:

1. A device for disengaging a bottle cap from a bottle comprising:
an elongated handle having a first half and a second half and a long axis, wherein a pivot surface of the elongated handle is configured to contact a first edge on a bottle cap at a pivot axis, and wherein the handle pivots around the pivot axis, the pivot axis being perpendicular to the long axis;
a tooth embedded in the first half of the elongated handle, the tooth having a first portion substantially perpendicular to the pivot surface of the elongated handle and a second portion angled substantially perpendicular to the first portion, the first and second portions joined by an angled portion, the second portion having an arcuate end shaped to engage a neck of the bottle, and wherein the arcuate end engages the neck of the bottle and a bottom of the bottle cap, and wherein the elongated handle pivots around the pivot axis causing the tooth to force at least a portion of the bottle cap off of the bottle.

2. The device of claim 1, wherein the arcuate end has a convex elliptical shape.

3. The device of claim 2, wherein the arcuate end has a circular shape.

4. The device of claim 3, wherein the arcuate end has a one half-inch radius.

5. The device of claim 1, wherein the tooth is embedded in the elongated handle at a position that is closer to an end of the first half than to a middle point of the pivot surface.

6. The device of claim 5, wherein the tooth is between one to two inches from the end of the first half.

7. The device of claim 1, wherein substantially perpendicular includes the angles 80 to 95 degrees.

8. The device of claim 7, wherein the angled portion is angled or curved between 80 to 95 degrees.

9. The device of claim 8, wherein a distance from the angled portion to an end of the second portion is three eighths of an inch.

10. The device of claim 1, wherein the elongated handle is made of wood.

11. The device of claim 10, wherein the tooth is made of metal.

12. The device of claim 1, wherein the first portion of the tooth is three eighths of an inch long.

13. A method of disengaging a bottle cap from a bottle comprising:
first engaging a neck of the bottle and a bottom of the bottle cap with a tooth of a bottle opening device;
second engaging a first edge of the bottle cap with a pivot surface of the bottle opening device; and
pivoting the bottle opening device about the first edge of the bottle until the tooth forces at least a portion of the bottle cap to disengage from the bottle.

14. The method of claim 13, wherein the second engaging precedes the first engaging.

15. The method of claim 13, wherein said step of pivoting comprises gripping a handle of the bottle opening device and moving the handle downwardly.

16. A tooth of a bottle opening device comprising:
an attachment portion configured to secure the tooth to the bottle opening device;
a first portion aligned with the attachment portion and protruding from a pivot surface of the bottle opening device; and
a second portion angled substantially perpendicular to the first portion and including an arcuate end shaped to engage a neck of a bottle and a bottom surface of a bottle cap of the bottle.

17. The tooth of claim 15, wherein the tooth is attached to a bottle opening device via the attachment portion.

18. The tooth of claim 16, wherein an arrow-shaped portion of the attachment portion is embedded in the bottle opening device.

19. The tooth of claim 17, wherein the arrow-shaped portion connects to the first portion via a causeway portion.

20. The tooth of claim 15, wherein the first portion is tapered toward the attachment end.

21. The tooth of claim 15, wherein the arcuate end has a one half-inch radius.
